(19) United States
(12) Patent Application Publication
(10) Pub. No.: US 2023/0259672 A1
(43) Pub. Date: Aug. 17, 2023

(54) BATTERY SIMULATOR METHOD USING TWO-BRANCH EQUIVALENT CIRCUIT MODEL

(71) Applicant: Samsung SDI Co., Ltd., Yongin-si, Gyeonggi-do (KR)

(72) Inventors: Jake Kim, Yongin-si (KR); Hoyul Baek, Yongin-si (KR); Yoohong Jang, Yongin-si (KR); Yeongbeom Joe, Yongin-si (KR); Minjeong Kang, Yongin-si (KR); Gijang Ahn, Yongin-si (KR); Yongjun Hwang, Yongin-si (KR); Byeonghui Lim, Yongin-si (KR); Giheon Kim, Yongin-si (KR)

(21) Appl. No.: 18/003,971

(22) PCT Filed: Dec. 2, 2021
(86) PCT No.: PCT/KR2021/018153

§ 371 Date: Feb. 15, 2023

(30) Foreign Application Priority Data
Apr. 19, 2021 (KR) 10-2021-0050707

(51) Int. Cl. G06F 30/20

(52) U.S. Cl. CPC G06F 30/20; G06F 2111/10

(57) ABSTRACT

Provided is a battery simulation method performed by a computing device including a processor and a memory. The battery simulation method includes selecting an equivalent circuit model of a battery including first and second branches, setting a capacity ratio of the first and second branches, receiving a current value, estimating a distribution current value distributed to each branch, updating a state of charge (SOC) value of each branch, determining an open circuit voltage value, a series resistance value, a first parallel resistance value, a second parallel resistance value, a first capacitance, and a second capacitance of each branch, based on the SOC value of each branch, determining a first voltage value of both ends of a first parallel resistor and a second voltage value of both ends of a second parallel resistor, of each branch, calculating a G parameter value and an H parameter value of the battery, and calculating an estimated voltage value of the battery

### TECHNICAL FIELD

The present disclosure relates to a battery simulation method using a 2-branch equivalent circuit model.

### BACKGROUND ART

Compared to other energy storage devices, batteries are highly applicable and have relatively high energy, power density, etc., and thus, are widely applied not only to portable devices, but also to electric vehicles (EVs), hybrid electric vehicles (HEVs), or the like, driven by an electrical driving source. To obtain a capacity and output required for each use, a battery pack in which a plurality of batteries are connected to each other in series and in parallel may be used. To efficiently and safely use an electric device driven by a battery or a battery pack, it is necessary to accurately estimate an internal state.

Representative models that may be used to estimate an internal state of a battery may include an equivalent circuit model and an electrochemical model.

An equivalent circuit model (ECM) determines, through preliminary experiments, how virtual equivalent circuit components such as a resistance R, a capacitance C, and an open circuit voltage Voc vary according to variables such as current I, a voltage V, and a temperature T. It takes a lot of time and effort to organize this tendency into a table. Also, when a result is outside an experimental range, reliability may be degraded because extrapolation should be performed. Despite these problems, an ECM has a simple structure, and thus, is widely used in a battery management system (BMS), etc. requiring fast calculation.

An electrochemical model may improve the estimation accuracy of an internal state by electrochemically simulating a phenomenon in a battery. However, the electrochemical model requires too many resources for calculation, and thus, is not as widely used as the ECM.

Even in a simple battery equivalent circuit model, a calculation time increases rapidly when batteries of a battery pack are connected in series and in parallel. In order to overcome these disadvantages, the inventors have developed a GH-ECM method (Korean Patent Application No. 10-2020-0096938). A calculation speed of estimating a battery state in a battery pack has been increased by applying a GH method to an ECM.

### DESCRIPTION OF EMBODIMENTS

### Technical Problem

The present disclosure provides a battery simulation method for rapidly and accurately estimating a battery voltage and an internal state by using a GH-two-branch equivalent circuit model (ECM) that improves the accuracy of an ECM while maintaining a high calculation speed of a GH-ECM method.

### Solution to Problem

According to an aspect of the present disclosure, a battery simulation method performed by a computing device including a processor and a memory includes selecting an equivalent circuit model of a battery including first and second branches including a voltage source connected in series, a series resistor, a first parallel resistor and a first capacitor connected in parallel, and a second parallel resistor and a second capacitor connected in parallel, setting a capacity ratio of the first and second branches, receiving a current value, estimating a distribution current value distributed to each branch, updating a state of charge (SOC) value of each branch, based on the distribution current value of each branch, determining an open circuit voltage value, a series resistance value, a first parallel resistance value, a second parallel resistance value, a first capacitance, and a second capacitance of each branch, based on the SOC value of each branch, determining a first voltage value of both ends of the first parallel resistor and a second voltage value of both ends of the second parallel resistor of each branch, calculating a G parameter value and an H parameter value of the battery, based on the open circuit voltage value, the series resistance value, the first voltage value, and the second voltage value, of each branch, and calculating an estimated voltage value of the battery, based on the G parameter value and the H parameter value of the battery.

According to another aspect of the present disclosure, there is provided a computer program stored in a medium to execute a battery simulation method by using a computing device including a processor and a memory.

### Advantageous Effects of Disclosure

The present disclosure has great improvements in terms of accuracy and adaptability, compared to previous methods. An existing equivalent circuit model (ECM) is based on uniformity of a battery because current flows along a single path. However, because non-uniformity in a battery increases in a special situation such as a high C-rate (discharge rate) or a low ambient air temperature, the accuracy of a single path (1-branch) ECM rapidly decreases. The present disclosure may achieve high accuracy even in the above special situation by adopting a plurality of current paths to reflect non-uniformity of a battery in a model.

### BRIEF DESCRIPTION OF DRAWINGS

FIG. 1 is a schematic diagram illustrating a computing device for performing a battery simulation method, according to an embodiment.

FIG. 2 illustrates a 1-branch equivalent circuit model of a battery.

FIG. 3 illustrates parameter data of a 1-branch equivalent circuit model stored in a memory, according to an embodiment.

FIG. 4A illustrates a series resistance value Rs according to a state of charge (SOC) value of a battery.

FIG. 4B illustrates a first parallel resistance value Rp₁ and a second parallel resistance value Rp₂ according to an SOC value of a battery.

FIG. 5 illustrates a battery model that performs a battery simulation method, according to an embodiment.

FIG. 6 illustrates a 2-branch equivalent circuit model as a battery model, according to an embodiment.

FIG. 7 is a flowchart for describing a battery simulation method performed by a computing device, according to an embodiment.

FIG. 8 illustrates an estimated voltage value calculated according to a battery simulation method, according to an embodiment.

FIG. 9 illustrates a battery model for performing a method of determining a capacity ratio α, according to an embodiment.

FIG. 10 is a flowchart for describing a method of determining a capacity ratio α performed by a computing device, according to an embodiment.

### BEST MODE

The advantages and features of the present disclosure, and methods of achieving the same, will become apparent with reference to embodiments of the disclosure described below in detail in conjunction with the accompanying drawings. However, the present disclosure is not limited to embodiments presented below but may be embodied in various different forms, and it is to be appreciated that all changes, equivalents, and substitutes that do not depart from the spirit and technical scope of the present disclosure are encompassed in the present disclosure. The embodiments described below are provided to completely disclose the disclosure so that one of ordinary skill in the art may thoroughly understand the scope of the disclosure. In the description of the present disclosure, certain detailed explanations of the related art are omitted when it is deemed that they may unnecessarily obscure the essence of the present disclosure.

The terms used in the present application are merely used to describe specific embodiments, and are not intended to limit the present disclosure. The singular forms “a,” “an,” and “the” are intended to include the plural forms as well, unless the context clearly indicates otherwise. Further, as used in this application, the terms “include,” “have” and their conjugates may be construed to denote a certain feature, number, step, operation, constituent element, component, or a combination thereof, but may not be construed to exclude the existence or addition of one or more other features, numbers, steps, operations, constituent elements, components, or combinations thereof. It will be understood that although the terms “first,” “second,” etc. may be used herein to describe various components, these components should not be limited by these terms. The above terms are used only to distinguish one element from another.

A multi-branch ECM proposed in the present disclosure simulates non-uniformity of an internal state of a battery by using two or more branches. This may be microscopically interpreted as non-uniformity in an active material, and may be macroscopically interpreted as non-uniformity of a battery cell. For example, when a battery is discharged at a high discharge rate (C-rate), lithium in an outer part of an active material may be microscopically first used, and lithium in a part close to a battery electrode may be macroscopically preferentially used, thereby causing non-uniformity. To describe internal non-uniformity that inevitably occurs when a battery is used, as many paths as necessary may be used. Also, to better reflect material characteristics, a modification of dividing into a positive electrode portion and a negative electrode portion may be made. In this case, a non-uniform state in a battery may be accurately simulated through sophistication, such as increasing the number of branches connected in parallel or connecting bundles of branches in series.

Although the present disclosure is described assuming that two branches are used, a battery equivalent circuit model using three or more branches may be used when necessary.

Hereinafter, embodiments of the present disclosure will be described in detail with reference to the accompanying drawings, wherein the same or corresponding elements throughout are denoted by the same reference numerals and a repeated description thereof is omitted.

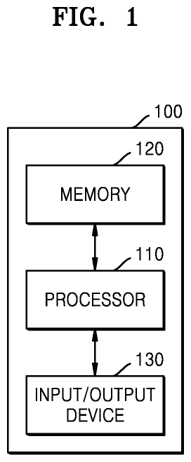

FIG. 1 is a schematic diagram illustrating a computing device for performing a battery simulation method, according to an embodiment.

Referring to FIG. 1, a computing device 100 includes a processor 110, a memory 120, and an input/output device 130.

The processor 110 may perform basic arithmetic, logic, and input/output operations. For example, the processor 110 may execute program code stored in the memory 120 or may read data stored in the memory 120 to use the data for the operations. The processor 110 may perform a battery simulation method according to an embodiment.

The processor 110 may be configured to select an equivalent circuit model of a battery including first and second branches including a voltage source connected in series, a series resistor, a first parallel resistor and a first capacitor connected in parallel, and a second parallel resistor and a second capacitor connected in parallel, set a capacity ratio of the first and second branches, receive a current value, estimate a distribution current value distributed to each branch, update a state of charge (SOC) value of each branch based on the distribution current value of each branch, determine an open circuit voltage value, a series resistance value, a first parallel resistance value, a second parallel resistance value, a first capacitance, and a second capacitance of each branch based on the SOC value of each branch, determine a first voltage value of both ends of the first parallel resistor and a second voltage value of both ends of the second parallel resistor of each branch, calculate a G parameter value and an H parameter value of a battery based on the open circuit voltage value, the series resistance value, the first voltage value, and the second voltage value of each branch, and calculate an estimated voltage value of the battery based on the G parameter value and the H parameter value of the battery.

The processor 110 may achieve simulation of the battery by repeatedly performing a process of receiving a new current value, estimating a distribution current value distributed to each branch in response to the received new current value, determining an SOC value, parameter values, and first and second voltage values of each branch, and calculating a G parameter value and an H parameter value of the battery and an estimated voltage value of the battery.

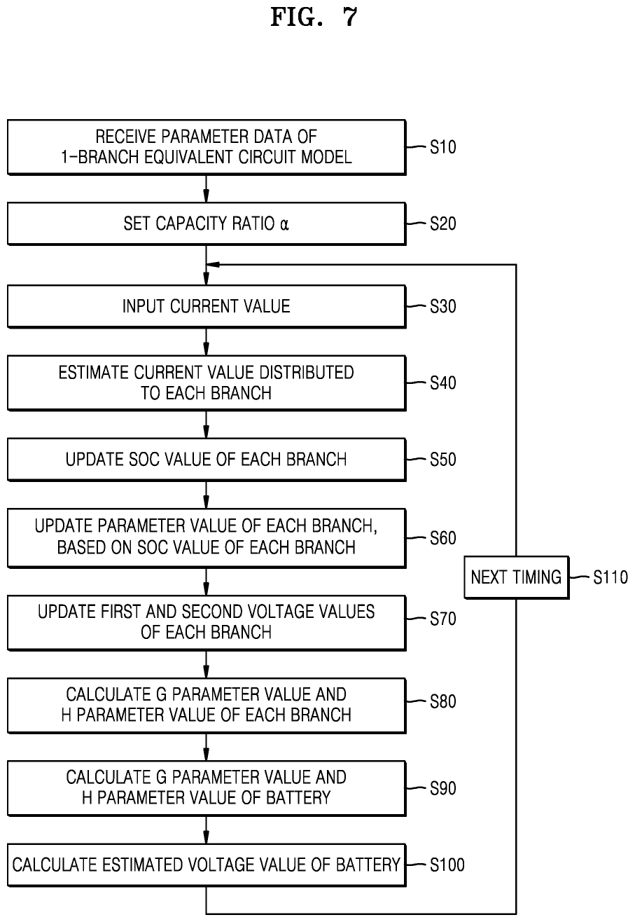

A battery simulation method will now be described in more detail below with reference to FIG. 7.

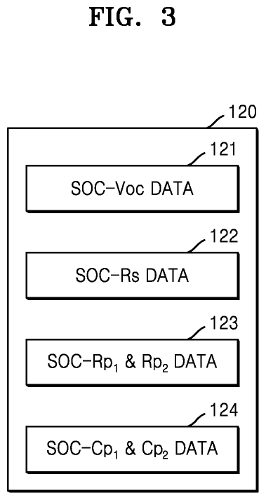

The memory 120 that is a recording medium readable by the processor 110 of the computing device 100 may include a random-access memory (RAM), a read-only memory (ROM), and a permanent mass storage device such as a disk drive. An operating system and at least one program or application code may be stored in the memory 120. Program code for executing a battery simulation method according to an embodiment may be stored in the memory 120. Also, a look-up table defining parameter data of each parameter value used in a 1-branch equivalent circuit model (ECM) illustrated in FIG. 3 in response to an SOC value of a battery may be stored in the memory 120.

The input/output device 130 may receive an input from a user, may transmit the input to the processor 110, and may output information received from the processor 110 to the user. The computing device 100 may include a communication module, and the communication module may receive an input from the user, may transmit the input to the processor 110, and may transmit information received from the processor 110 to the user.

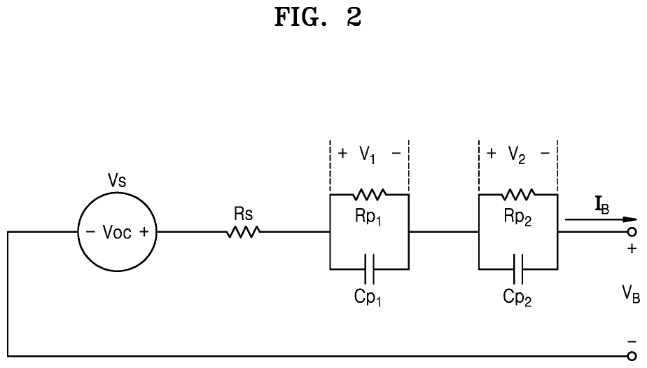

FIG. 2 illustrates a 1-branch equivalent circuit model of a battery.

As shown in FIG. 2, the 1-branch equivalent circuit model may be a second-order Thevenin model. The 1-branch equivalent circuit model includes a voltage source Voc connected in series, a series resistor Rs, a first parallel resistor Rp₁ and a first capacitor Cp₁ connected in parallel, and a second parallel resistor Rp₂ and a second capacitor Cp₂ connected in parallel. The voltage source Voc, the series resistor Rs, the first parallel resistor Rp₁ and the first capacitor Cp₁, and the second parallel resistor Rp₂ and the second capacitor Cp₂ may constitute one branch.

Battery current I_{B} indicates discharge current of the battery, and a battery voltage V_{B} indicates a terminal voltage of the battery. The battery current I_{B} having a negative value indicates charging current of the battery.

A voltage at both ends of the first parallel resistor Rp₁ and the first capacitor Cp₁ connected in parallel is represented as a first voltage V₁, and a voltage at both ends of the second parallel resistor RP_{2and} the second capacitor Cp₂ is represented as a second voltage V₂.

An open circuit voltage value Voc of a voltage source Vs, a series resistance value Rs, a first parallel resistance value Rp₁ and a first capacitance Cp₁, and a second parallel resistance value Rp₂ and a second capacitance Cp₂ vary according to an SOC value of the battery. For example, as the SOC value of the battery decreases, the open circuit voltage value Voc of the voltage source Vs decreases and the series resistance value Rs increases.

The open circuit voltage value Voc, the series resistance value Rs, the first parallel resistance value Rp₁ and the first capacitance Cp₁, and the second parallel resistance value Rp₂ and the second capacitance Cp₂ according to the SOC value of the battery may be examined and may be stored in the memory 120.

Although the 1-branch equivalent circuit model is a second-order Thevenin model, the 1-branch equivalent circuit model may be a first-order Thevenin model without the second parallel resistor Rp₂ and the second capacitor Cp₂.

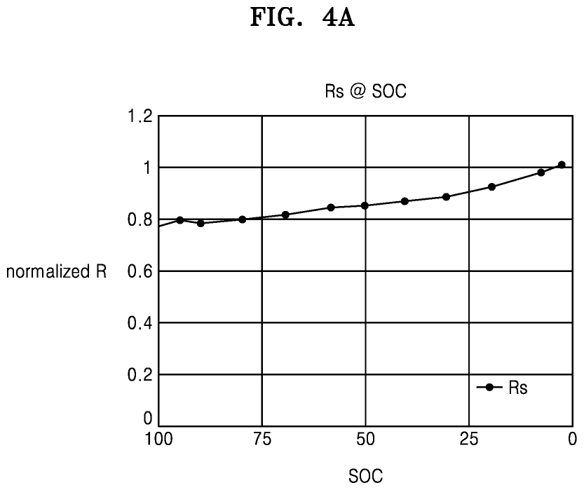

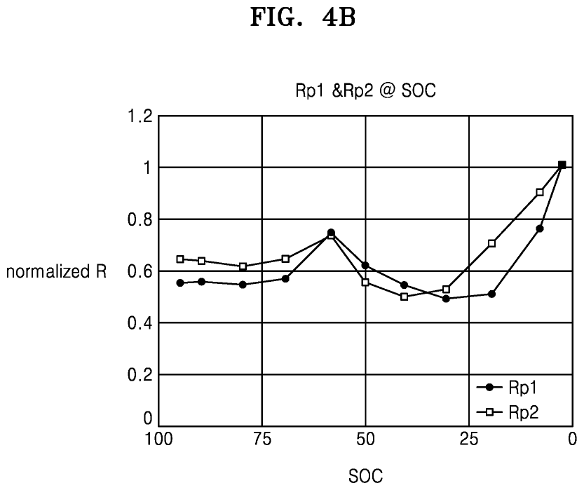

FIG. 3 illustrates parameter data of a 1-branch equivalent circuit model stored in a memory, according to an embodiment. FIG. 4A illustrates a series resistance value Rs according to an SOC value of a battery. FIG. 4B illustrates a first parallel resistance value Rp₁ and a second parallel resistance value Rp₂ according to an SOC value of a battery.

Referring to FIGS. 2 and 3 together, SOC-Voc data 121 may be stored in the memory 120. An open circuit voltage value Voc of a voltage source Vs according to an SOC value of a battery may be stored as a table in the memory 120.

SOC-Rs data 122 may be stored in the memory 120. A series resistance value Rs according to an SOC value of a battery may be stored as a table in the memory 120. FIG. 4A illustrates a series resistance value Rs according to an SOC value of a battery. As the SOC value of the battery decreases, the series resistance value Rs increases. Although the series resistance value Rs is a normalized value in FIG. 4A, an actual series resistance value Rs may be stored in the memory 120.

SOC-Rp₁ & Rp₂ data 123 may be stored in the memory 120. A first parallel resistance value Rp₁ and a second parallel resistance value Rp₂ according to an SOC value of a battery may be stored as a table in the memory 120. FIG. 4B illustrates a first parallel resistance value Rp₁ and a second parallel resistance value Rp₂ according to an SOC value of a battery. Although the first parallel resistance value Rp₁ and the second parallel resistance value Rp₂ are normalized values in FIG. 4B, an actual first parallel resistance value Rp₁ and an actual second parallel resistance value Rp₂ may be stored in the memory 120.

SOC-Cp₁ & Cp₂ data 124 may be stored in the memory 120. A first capacitance Cp₁ and a second capacitance Cp₂ according to an SOC value of a battery may be stored as a table in the memory 120. According to another embodiment, because the first capacitance Cp₁ and the second capacitance Cp₂ do not greatly vary according to the SOC value of the battery, the first capacitance Cp₁ and the second capacitance Cp₂ may be stored as constants in the memory 120.

Parameter data of the 1-branch equivalent circuit model that is data stored in the memory 120 may include the SOC-Voc data 121, the SOC-Rs data 122, the SOC-Rp₁ & Rp₂ data 123, and the SOC-Cp₁ & Cp₂ data 124.

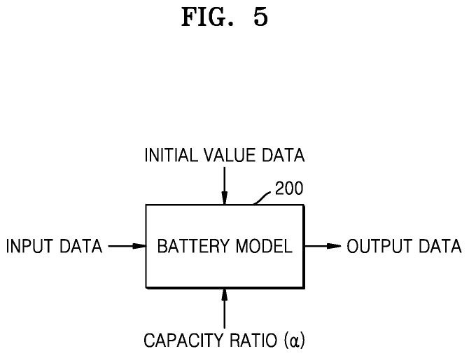

FIG. 5 illustrates a battery model that performs a battery simulation method, according to an embodiment.

Referring to FIG. 5, a battery model 200 may be executed by the processor 110. When program code for executing a battery simulation method stored in the memory 120 is executed by the processor 110, the processor 110 may operate as the battery model 200.

When initial value data and input data are input to the battery model 200, the battery model outputs output data corresponding to the input data. According to an example, the input data may be a current value of a battery, and the output data may be an estimated voltage value of the battery. The initial value data may be parameter data of a 1-branch equivalent circuit model stored in the memory 120.

A capacity ratio α may be input to the battery model 200. The battery model 200 may be a 2-branch equivalent circuit model including a first branch and a second branch. The capacity ratio α is a capacity ratio between the first branch and the second branch, and a capacity of the first branch may be a times a capacity of the second branch. The first branch may be defined as a branch having a larger capacity from among the first branch and the second branch, and the capacity ratio α may be equal to or greater than 1. For example, the capacity ratio α may be a value selected in a range of 1 or more and 10 or less. According to another example, the capacity ratio α may be a value selected in a range of 1 or more and 5 or less. In a specific example, the capacity ratio α may be about 2.2.

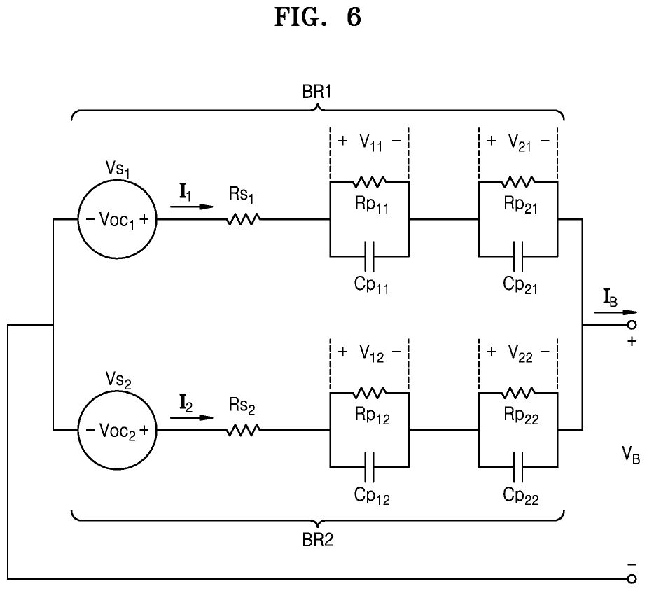

FIG. 6 illustrates a 2-branch equivalent circuit model as a battery model, according to an embodiment.

Referring to FIG. 6, a 2-branch equivalent circuit model models a battery, and includes a first branch BR1 and a second branch BR2 that are connected to each other in parallel. In the present specification, a 2-branch equivalent circuit model is simply referred as an equivalent circuit model, and a 1-branch equivalent circuit model is referred to as a 1-branch equivalent circuit model.

The battery modeled by the 2-branch equivalent circuit model may be one battery cell, a plurality of battery cells connected to each other in series and/or in parallel, or one battery pack including a plurality of battery cells.

A battery cell may include a rechargeable secondary battery. For example, the battery cell may include a nickel-cadmium battery, a lead storage battery, a nickel metal hydride (NiMH) battery, a lithium ion battery, and a lithium polymer battery.

The first branch BR1 includes a voltage source Vs₁ connected in series, a series resistor Rs₁, a first parallel resistor Rp₁₁ and a first capacitor Cp₁₁ connected in parallel, and a second parallel resistor Rp₂₁ and a second capacitor Cp₂₁ connected in parallel. In the first branch BR1, a voltage at both ends of the first parallel resistor Rp₁₁ and the first capacitor Cp₁₁ connected in parallel is represented as a first voltage V₁₁, and a voltage at both ends of the second parallel resistor Rp₂₁ and the second capacitor Cp₂₁ connected in parallel is represented as a second voltage V₂₁.

The second branch BR2 also includes a voltage source Vs₂, connected in series, a series resistor Rs₂, a first parallel resistor Rp₁₂ and a first capacitor Cp₁₂ connected in parallel, and a second parallel resistor Rp₂₂ and a second capacitor Cp₂₂ connected in parallel. In the second branch BR2, a voltage at both ends of the first parallel resistor Rp₁₂ and the first capacitor Cp₁₂ connected in parallel is represented as a first voltage V₁₂, and a voltage at both ends of the second parallel resistor Rp₂₂ and the second capacitor Cp₂₂ connected in parallel is represented as a second voltage V₂₂.

A capacity Q₁ of the first branch BR1 is a times a capacity Q₂ of the second branch BR2. The capacity Q₁ of the first branch BR1 is α/(α+1) times an overall battery capacity Q, and the capacity Q₂ of the first branch BR1 is 1/(α+1) times the overall battery capacity Q. The overall battery capacity Q is the same as a sum of the capacity Q₁ of the first branch BR1 and the capacity Q₂ of the second branch BR2.

Battery current I_{B} is distributed to the first branch BR1 and the second branch BR2. Current flowing through the first branch BR1 is referred to as first distribution current I₁, and current flowing through the second branch BR2 is referred to as second distribution current I₂. A sum of the first distribution current I₁ and the second distribution current I₂ is the same as the battery current I_{B}. A battery voltage V_{B} is a terminal voltage of the battery.

FIG. 7 is a flowchart for describing a battery simulation method performed by a computing device, according to an embodiment.

Referring to FIG. 7, parameter data of a 1-branch equivalent circuit model that models a battery is received (S10). The parameter data of the 1-branch equivalent circuit model may include at least one of the SOC-Voc data 121 (see FIG. 3), the SOC-Rs data 122 (see FIG. 3), the SOC-Rp₁ & Rp₂ data 123 (see FIG. 3), and the SOC-Cp₁ & Cp₂ data 124 (see FIG. 3), and may be stored in the memory 120 (see FIG. 3). According to an example, a first capacitance Cp₁ and a second capacitance Cp₂ may be constants regardless of an SOC value.

A capacity ratio α of a first branch BR1 and a second branch BR2 may be set (S20). A sum of a capacity Q₁ of a first branch BR1 and a capacity Q₂ of a second branch BR2 is the same as an overall battery capacity Q. The capacity Q₁ of the first branch BR1 is α/(α+1) times the overall battery capacity Q, and the capacity Q₂ of the first branch BR1 is 1/(α+1) times the overall battery capacity Q.

According to an example, the capacity ratio α may be a value selected in a range of 1 or more and 10 or less. According to another example, the capacity ratio α may be a value selected in a range of 1 or more and 5 or less. In a specific example, the capacity ratio α may be about 2.2.

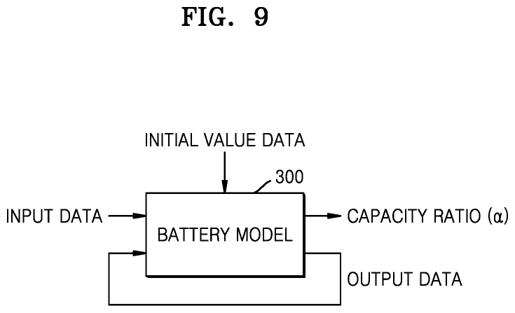

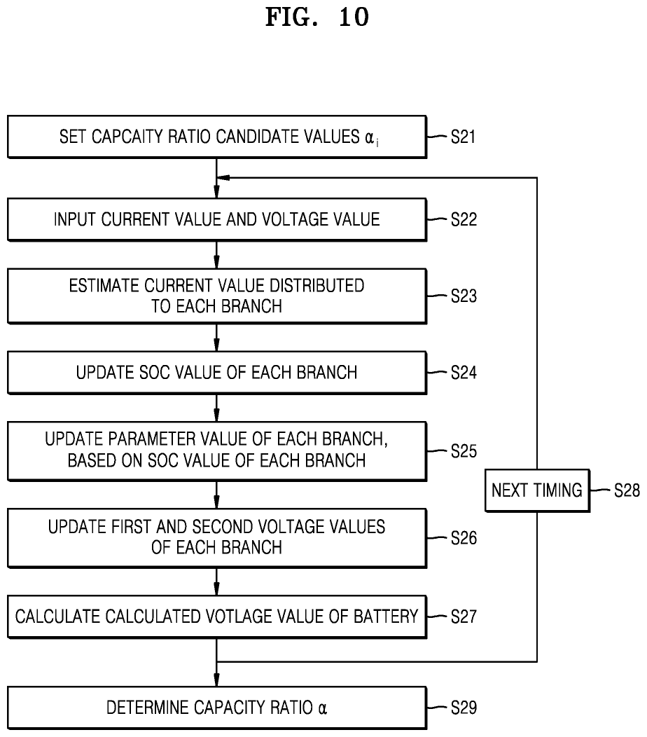

A method of determining the capacity ratio α will be described in more detail below with reference to FIGS. 9 and 10.

According to a battery simulation method according to an embodiment, operations S30 to S110 are repeatedly performed with respect to a current value input to the battery 200 at each pre-set timing interval Δt, and an estimated voltage value corresponding to the current value input at each pre-set timing interval Δt is output at each pre-set timing interval Δt. When the estimated voltage value is not different from an actual voltage value, the battery model 200 models the actual battery well.

A process of performing operations S30 to S100 from a previous timing k−1 that is earlier than a current timing k by the pre-set timing interval Δt will be briefly described.

A current value I_{B}[k−1] of the previous timing k−1 may be input (S30). Distribution current values I₁[k−1] and I₂[k−1] distributed to the first and second branches BR1 and BR2 are estimated (S40). SOC values SOC₁[k−1] and SOC₂[k−1] of the first and second branches BR1 and BR2 are updated based on the distribution current values I₁[k−1] and I₂[k−1] of the first and second branches BR1 and BR2 (S50).

Open circuit voltage values Voc₁[k−1] and Voc₂[k−1], series resistance values Rs₁[k−1] and Rs₂[k−1], first parallel resistance values Rp₁₁[k−1] and Rp₁₂[k−1], second parallel resistance values Rp₂₁[k−1] and Rp₂₂[k−1], first capacitances Cp₁₁[k−1] and Cp₁₂[k−1], and second capacitances Cp₂₁[k−1] and Cp₂₂[k−1] of the first and second branches BR1 and BR2 are updated based on the SOC values SOC₁[k−1] and SOC₂[k−1] of the first and second branches BR1 and BR2 (S60). First voltage values V₁₁[k−1] and V₁₂[k−1] of both ends of first parallel resistors Rp₁₁ and Rp₁₂ and second voltage values V₂₁[k−1] and V₂₂[k−1] of both ends of second parallel resistors Rp₂₁ and Rp₂₂ of the first and second branches BR1 and BR2 are updated (S70).

G parameter values G₁[k−1] and G₂[k−1] and H parameter values H₁[k−1] and H₂[k−1] of the first and second branches BR1 and BR2 may be calculated based on the open circuit voltage values Voc₁[k−1] and Voc₂[k−1], the series resistance values Rs₁[k−1] and Rs₂[k−1], the first voltage values V₁₁[k−1] and V₁₂[k−1], and the second voltage values V₂₁[k−1] and V₂₂[k−1] of the first and second branches BR1 and BR2 (S80). A G parameter value G_{B}[k−1] and an H parameter value H_{B}[k−1] of the battery may be calculated based on the G parameter values G₁[k−1] and G₂[k−1] and the H parameter values H₁[k−1] and H₂[k−1] of the first and second branches BR1 and BR2 (S90). An estimated voltage value V_{B_est}[k−1] of the battery may be calculated based on the G parameter value G_{B}[k−1] and the H parameter value H_{B}[k−1] of the battery (S100).

When the pre-set timing interval Δt passes (S110) to reach the current timing k, a current value I_{B}[k] of the current timing k is input (S30). The input current I_{B} is distributed to the first and second branches BR1 and BR2.

A first distribution current value I₁[k] distributed to the first branch BR1 and a second distribution current value I₂[k] distributed to the second branch BR2 are estimated (S40). The first distribution current value I₁[k]) may be estimated based on the first and second open circuit voltage values Voc₁[k−1] and Voc₂[k−1], the first and second series resistance values Rs₁[k−1] and Rs₂[k−1], and the first voltage values V₁₁[k−1] and V₁₂[k−1] and the second voltage values V₂₁[k−1] and V₂₂[k−1] of the first and second branches BR1 and BR2, updated at the previous timing k−1, and the current value I_{B}[k] received at the current timing k.

According to an example, the first distribution current value I₁[k] may be estimated by using Equation 1.

I₁[k]={(Voc₁[k−1]−V₁₁[k−1]−V₂₁[k−1])−(Voc₂[k−1]−V₁₂[k−1]−V₂₂[k−1])+I_{B}[k]Rs₂[k−1]}/(Rs₁[k−1]+Rs₂[k−1]) [Equation 1]

The first and second open circuit voltage values Voc₁[k−1] and Voc₂[k−1] and the first and second series resistance values Rs₁[k−1] and Rs₂[k−1] may be values updated in operation S60 of the previous timing k−1. The first voltage values V₁₁[k−1] and V₁₂[k−1] and the second voltage values V₂₁[k−1] and V₂₂[k−1] of the first and second branches BR1 and BR2 may be values updated in operation S70 of the previous timing k−1.

The second distribution current value I₂[k] may be estimated by using Equation 2.

I₂[k]=I_{B}[k]−I₁[k] [Equation 2]

A first SOC value SOC₁[k] of the first branch BR1 is updated based on the first distribution current value I₁[k], and a second SOC value SOC₂[k] of the second branch BR2 is updated based on the second distribution current value I₂[k] (S50). For example, the first SOC value SOC₁[k] and the second SOC value SOC₂[k] may be calculated by using a current integration method.

According to an example, the first SOC value SOC₁[k] may be calculated based on the first distribution current value I₁[k] and the first SOC value SOC₁[k−1] of the previous timing k−1. For example, the first SOC value SOC₁[k] may be calculated by using Equation 3.

SOC₁[k]=SOC₁[k−1]−(I₁[k]×Δt)/(3600×Q₁) [Equation 3]

Here, Δt is a difference between the previous timing k−1 and the current timing k, that is, the pre-set timing interval Δt, and Q₁ is the capacity of the first branch BR1. The first distribution current value I₁[k] is a value estimated in operation S40.

In the same manner, the second SOC value SOC₂[k] may be calculated based on the second distribution current value I₂[k] and the second SOC value SOC₂[k−1] of the previous timing k−1. For example, the second SOC value SOC₂[k] may be calculated by using Equation 4.

SOC₂[k]=SOC₂[k−1]−(I₂[k]×Δt)/(3600×Q₂) [Equation 4]

Here, Δt is a difference between the previous timing k−1 and the current timing k, that is, the pre-set timing interval Δt, and Q₂ is the capacity of the second branch BR2. The second distribution current value I₂[k] is a value estimated in operation S40.

A first open circuit voltage value Voc₁[k], a first series resistance value Rs₁[k], a first parallel resistance value Rp₁₁[k], a second parallel resistance value Rp₂₁[k], a first capacitance Cp₁₁[k], and a second capacitance Cp₂₁[k] of the first branch BR1 are updated based on the first SOC value SOC₁[k], and a second open circuit voltage value Voc₂[k], a second series resistance value Rs₂[k], a first parallel resistance value Rp₁₂[k], a second parallel resistance value Rp₂₂[k], a first capacitance Cp₁₂[k], and a second capacitance Cp₂₂[k] of the second branch BR2 are updated based on the second SOC value SOC₂[k] (S60).

When the first SOC value SOC₁[k] and the second SOC value SOC₂[k] are determined in operation S50, by using the SOC-Voc data 121 (see FIG. 3) stored in the memory 120 (see FIG. 3), the first open circuit voltage value Voc₁[k] of the first branch BR1 is determined to be a value corresponding to the first SOC value SOC₁[k], and the second open circuit voltage value Voc₂[k] of the second branch BR2 is determined to be a value corresponding to the second SOC value SOC₂[k].

The first series resistance value Rs₁[k] of the first branch BR1 is determined to be a value obtained by multiplying a series resistance value Rs(SOC₁[k]) corresponding to the first SOC value SOC₁[k] by a first coefficient k1 by using the SOC-Rs data 122 (see FIG. 3) stored in the memory 120 (see FIG. 3), and the second series resistance value Rs₂[k] of the second branch BR2 is determined to be a value obtained by multiplying a series resistance value Rs(SOC₂[k]) corresponding to the second SOC value SOC₂[k] by a sixth coefficient k6 by using the SOC-Rs data 122 (see FIG. 3) stored in the memory 120 (see FIG. 3).

The first coefficient k1 and the sixth coefficient k6 may be determined based on the capacity ratio α, and for example, the first coefficient k1 may be 1+1/α and the sixth coefficient k6 may be 1+α.

For example, the first series resistance value Rs₁[k] of the first branch BR1 may be determined to be (1+1/α)*Rs(SOC₁[k]), and the second series resistance value Rs₂[k] of the second branch BR2 may be determined to be (1+α)*Rs(SOC₂[k]). Rs(SOC[k]) is a function for the SOC-Rs data 122 (see FIG. 3), and refers to a series resistance value corresponding to an SOC value SOC[k].

The first parallel resistance value Rp₁₁[k] and the second parallel resistance value Rp₂₁[k] of the first branch BR1 are determined to be values obtained by multiplying a first parallel resistance value Rp₁(SOC₁[k]) and a second parallel resistance value Rp₂(SOC₁[k]) corresponding to the first SOC value SOC₁[k] by a second coefficient k2 and a third coefficient k3 by using the SOC-Rp₁ & Rp₂ data 123 (see FIG. 3) stored in the memory 120 (see FIG. 3). The first parallel resistance value Rp₁₂[k] and the second parallel resistance value Rp₂₂[k] of the second branch BR2 are determined to be values obtained by multiplying a first parallel resistance value Rp₁(SOC₂[k]) and a second parallel resistance value Rp₂(SOC₂[k]) corresponding to the second SOC value SOC₂[k] by a seventh coefficient k7 and an eighth coefficient k8 by using the SOC-Rp₁ & Rp₂ data 123 (see FIG. 3) stored in the memory 120 (see FIG. 3).

The second coefficient k2, the third coefficient k3, the seventh coefficient k7, and the eighth coefficient k8 may be determined based on the capacity ratio α. For example, the second coefficient k2 and the third coefficient k3 may be 1+1/α, and the seventh coefficient k7 and the eighth coefficient k8 may be 1+α.

For example, the first parallel resistance value Rp₁₁[k] of the first branch BR1 may be determined to be (1+1/α)*Rp₁(SOC₁[k], and the second parallel resistance value Rp₂₁[k] of the first branch BR1 may be determined to be (1+1/α)*Rp₂(SOC₁[k]. The first parallel resistance value Rp₁₂[k] of the second branch BR2 may be determined to be (1+α)*Rp₁(SOC₂[k]), and the second parallel resistance value Rp₂₂[k] of the second branch BR2 may be determined to be (1+α)*Rp₂(SOC₂[k]). Rp₁(SOC[k]) and Rp₂(SOC[k]) are functions for the SOC-Rp₁ & Rp₂ data 123 (see FIG. 3), and refer to first and second parallel resistance values corresponding to the SOC value SOC[k].

The first capacitance Cp₁₁[k] and the second capacitance Cp₂₁[k] of the first branch BR1 are determined to be values obtained by multiplying a first capacitance Cp₁(SOC₁[k]) and a second capacitance Cp₂(SOC₁[k] corresponding to the first SOC value SOC₁[k] by a fourth coefficient k4 and a fifth coefficient k5 by using the SOC-Cp₁ & Cp₂ data 124 (see FIG. 3) stored in the memory 120 (see FIG. 3). The first capacitance Cp₁₂[k] and the second capacitance Cp₂₂[k] of the second branch BR2 are determined to be values obtained by multiplying a first capacitance Cp₁(SOC₂[k]) and a second capacitance Cp₂(SOC₂[k]) corresponding to the second SOC value SOC₂[k] by a ninth coefficient k9 and a tenth coefficient k10 by using the SOC-Cp₁ & Cp₂ data 123 (see FIG. 3) stored in the memory 120 (see FIG. 3).

The fourth coefficient k4, the fifth coefficient k5, the ninth coefficient k9, and the tenth coefficient k10 may be determined based on the capacity ratio α. For example, the fourth coefficient k4 and the fifth coefficient k5 may be (1+1/α)⁻¹, that is, α/(1+α), and the ninth coefficient k9 and the tenth coefficient k10 may be (1+α)⁻¹, that is, 1/(1+α).

For example, the first capacitance Cp₁₁[k] of the first branch BR1 may be determined to be α/(1+α)*Cp₁(SOC₁[k]), and the second capacitance Cp₂₁[k] of the first branch BR1 may be determined to be α/(1+α)*Cp₂(SOC₁[k]). The first capacitance Cp₁₂[k] of the second branch BR2 may be determined to be 1/(1+α)*Cp₁(SOC₂[k]), and the second capacitance Cp₂₂[k] of the second branch BR2 may be determined to be 1/(1+α)*Cp₂(SOC₂[k]). Cp₁(SOC[k]) and Cp₂(SOC[k]) are functions for the SOC-Cp₁ & Cp₂ data 124 (see FIG. 3), and refer to first and second capacitances corresponding to the SOC value SOC[k].

According to another example, the first capacitance Cp₁₁[k] and the second capacitance Cp₂₁[k] of the first branch BR1, and the first capacitance Cp₁₂[k] and the second capacitance Cp₂₂[k] of the second branch BR2 may be determined to be constants regardless of the first SOC value SOC₁[k] and the second SOC value SOC₂[k]. In this case, the first capacitance Cp₁₁[k] of the first branch BR1 and the first capacitance Cp₁₂[k] of the second branch BR2 may be α:1. Also, the second capacitance Cp₂₁[k] of the first branch BR1 and the second capacitance Cp₂₂[k] of the second branch BR2 may also be α:1.

A first voltage value V₁₁[k] and a second voltage value V₂₁[k] of the first branch BR1 and a first voltage value V₁₂[k] and a second voltage value V₂₂[k] of the second branch BR2 are updated (S70).

The first voltage value V₁₁[k] of the first branch BR1 may be updated based on the first voltage value V₁₁[k−1] of the previous timing k−1, and the first distribution current I₁[k], the first parallel resistance value Rp₁₁[k], and the first capacitance Cp₁₁[k] of the current timing k. For example, the first voltage value V₁₁[k] of the first branch BR1 may be calculated according to Equation 5.

$${V}_{11} [ k ] = {V}_{11} [ k - 1 ] {e}^{\frac{- Δ t}{{Rp}_{11} [ k ] {Cp}_{11} [ k ]}} + {I}_{1} [ k ] {Rp}_{11} [ k ] ( 1 - {e}^{\frac{- Δ t}{{Rp}_{11} [ k ] {Cp}_{11} [ k ]}} ) \qquad [ Equation 5 ]$$

The second voltage value V₂₁[k] of the first branch BR1 may be updated based on the second voltage value V₂₁[k−1] of the previous timing k−1, and the first distribution current I₁[k], the second parallel resistance value Rp₂₁[k], and the second capacitance Cp₂₁[k] of the current timing k. For example, the second voltage value V₂₁[k] of the first branch BR1 may be calculated according to Equation 6.

$${V}_{21} [ k ] = {V}_{21} [ k - 1 ] {e}^{\frac{- Δ t}{{Rp}_{21} [ k ] {Cp}_{21} [ k ]}} + {I}_{1} [ k ] {Rp}_{21} [ k ] ( 1 - {e}^{\frac{- Δ t}{{Rp}_{21} [ k ] {Cp}_{21} [ k ]}} ) \qquad [ Equation 6 ]$$

The first voltage value V₁₂[k] of the second branch BR2 may be updated based on the first voltage value V₁₂[k−1] of the previous timing k−1, and the second distribution current I₂[k], the first parallel resistance value Rp₁₂[k], and the first capacitance Cp₁₂[k] of the current timing k. For example, the first voltage value V₁₂[k] of the second branch BR2 may be calculated according to Equation 7.

$${V}_{12} [ k ] = {V}_{12} [ k - 1 ] {e}^{\frac{- Δ t}{{Rp}_{12} [ k ] {Cp}_{12} [ k ]}} + {I}_{2} [ k ] {Rp}_{12} [ k ] ( 1 - {e}^{\frac{- Δ t}{{Rp}_{12} [ k ] {Cp}_{12} [ k ]}} ) \qquad [ Equation 7 ]$$

The second voltage value V₂₂[k] of the second branch BR2 may be updated based on the second voltage value V₂₂[k−1] of the previous timing k−1, and the second distribution current I₂[k], the second parallel resistance value Rp₂₂[k], and the second capacitance Cp₂₂[k] of the current timing k. For example, the second voltage value V₂₂[k] of the second branch BR2 may be calculated according to Equation 8.

$${V}_{22} [ k ] = {V}_{22} [ k - 1 ] {e}^{\frac{- Δ t}{{Rp}_{22} [ k ] {Cp}_{22} [ k ]}} + {I}_{2} [ k ] {Rp}_{22} [ k ] ( 1 - {e}^{\frac{- Δ t}{{Rp}_{22} [ k ] {Cp}_{22} [ k ]}} ) \qquad [ Equation 8 ]$$

A first G parameter value G₁[k] and a first H parameter value H₁[k] of the first branch BR1 may be calculated based on the first open circuit voltage value Voc₁[k], the first series resistance value Rs₁[k], and the first voltage value V₁₁[k] and the second voltage value V₂₁[k] of the first branch BR1, and a second G parameter value G₂[k] and a second H parameter value H₂[k] of the second branch BR2 may be calculated based on the second open circuit voltage value Voc₂[k], the second series resistance value Rs₂[k], and the first voltage value V₁₂[k] and the second voltage value V₂₂[k] of the second branch BR2 (S80).

The first G parameter value G₁[k] is a value indicating a sensitivity of a voltage to a change in current of the first branch BR1, and the first H parameter value H₁[k] is a value indicating an effective potential determined by a local equilibrium potential distribution and a resistance distribution in the second branch BR2. Also, the second G parameter value G₂[k] is a value indicating a sensitivity of a voltage to a change in current of the second branch BR2, and the second H parameter value H₂[k] is a value indicating an effective potential determined by a local equilibrium potential distribution and a resistance distribution in the second branch BR2.

According to an example, the first G parameter value G₁[k] of the first branch BR1 may be determined to be the first series resistance value Rs₁[k], and the second G parameter value G₂[k] of the second branch BR2 may be determined to be the second series resistance value Rs₂[k].

The first H parameter value H₁[k] of the first branch BR1 may be determined to be a value obtained by subtracting the first voltage value V₁₁[k] and the second voltage value V₂₁[k] from the first open circuit voltage value Voc₁[k] of the first branch BR1. Also, the second H parameter value H₂[k] of the second branch BR2 may be determined to be a value obtained by subtracting the first voltage value V₁₂[k] and the second voltage value V₂₂[k] from the second open circuit voltage value Voc₂[k] of the second branch BR2.

A G parameter value G_{B}[k] and an H parameter value H_{B}[k] of the battery modeled by the battery model 200 may be calculated based on the first G parameter value G₁[k] and the first H parameter value H₁[k] of the first branch BR1 and the second G parameter value G₂[k] and the second H parameter value H₂[k] of the second branch BR2 (S90).

The G parameter value G_{B}[k] of the battery is a value indicating a sensitivity of a voltage to a change in current of the battery, and the H parameter value H_{B}[k] of the battery is a value indicating an effective potential determined by a local equilibrium potential distribution and a resistance distribution in the battery.

The G parameter value G_{B}[k] of the battery may be calculated by Equation 9.

G_{B}[k]=((G₁[k])⁻¹+(G₂[k])⁻¹)⁻¹ [Equation 9]

The H parameter value H_{B}[k] of the battery may be calculated by Equation 10.

H_{B}[k]=(H₁[k]/G₁[k]+H₂[k]/G₂[k])/(1/G₁[k]+1/G₂[k]) [Equation 10]

An estimated voltage value V_{B_est}[k] of the battery modeled by the battery model 200 may be calculated based on the G parameter value G_{B}[k] and the H parameter value H_{B}[k] of the battery (S100).

The estimated voltage value V_{B_est}[k] of the battery is a voltage value corresponding to the input current value I_{B}[k] of the current timing k, and may be calculated by Equation 11.

V_{B_est}[k]=H_{B}[k]+G_{B}[k]*I_{B}[k] [Equation 11]

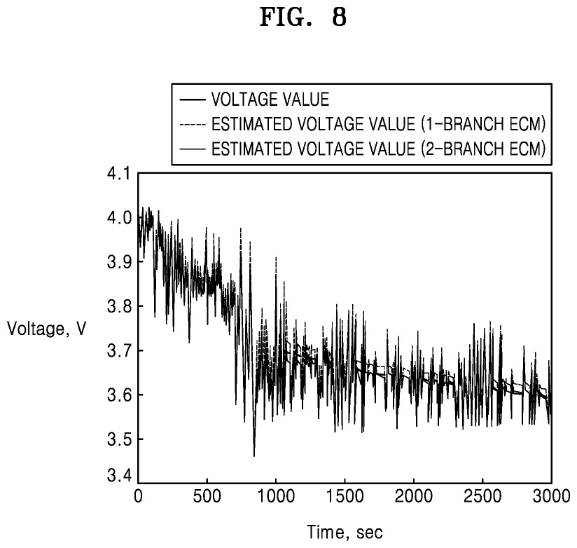

FIG. 8 illustrates an estimated voltage value calculated according to a battery simulation method, according to an embodiment.

FIG. 8 illustrates a voltage value that is actually measured, a voltage value that is estimated by using a 1-branch equivalent circuit model (ECM), and a voltage value that is estimated by using a 2-branch ECM according to the present disclosure.

A mean square error between the actual voltage value and the voltage value estimated by using the 1-branch ECM was 24 mV, and a mean square error between the actual voltage value and the voltage value estimated by using the 2-branch ECM was 15 mV.

A deviation of the voltage value estimated by using the 2-branch ECM was reduced by about 38% compared to the voltage value estimated by using the 1-branch ECM. That is, when the 2-branch ECM according to the present disclosure is used, a battery may be modeled more accurately.

FIG. 9 illustrates a battery model for performing a method of determining a capacity ratio α, according to an embodiment.

Referring to FIG. 9, a battery model 300 may be executed by the processor 110. When program code for executing a method of determining a capacity ratio stored in the memory 120 is executed by the processor 110, the processor 110 may operate as the battery model 300. The battery model 300 may be the same as the battery model 200.

When initial value data and input data are input to the battery model 300, the battery model 300 outputs output data corresponding to the input data. The output data is input back to the battery model 300. Pre-set capacity ratio candidate values αᵢ may be input to the battery model 300. The battery model 300 may determine an optimal capacity ratio α. The input data may be a current value of a battery, and the output data may be a calculated voltage value of the battery. The initial value data may be parameter data of a 1-branch ECM stored in the memory 120.

FIG. 10 is a flowchart for describing a method of determining a capacity ratio α performed by a computing device, according to an embodiment. A method of determining the capacity ratio α may be performed in operation S20 of FIG. 7.

Referring to FIG. 10, parameter data of a 1-branch ECM that models a battery may be received in operation S10 of FIG. 7, and the parameter data of the 1-branch ECM may include at least one of the SOC-Voc data 121 (see FIG. 3), the SOC-Rs data 122 (see FIG. 3), the SOC-Rp₁ & Rp₂ data 123 (see FIG. 3), and the SOC-Cp₁ & Cp₂ data 124 (see FIG. 3), and may be stored in the memory 120 (see FIG. 3).

Capacity ratio candidate values αᵢ of a first branch BR1 and a second branch BR2 may be set (S21). It is assumed that a capacity of the first branch is αᵢ times a capacity of the second branch. A sum of a capacity Q₁ of the first branch BR1 and a capacity Q₂ of the second branch BR2 is the same as an overall battery capacity Q, the capacity Q₁ of the first branch BR1 is αᵢ(αᵢ+1) times the overall battery capacity Q, and the capacity Q₂ of the first branch BR1 is 1/(αᵢ+1) times the overall battery capacity Q.

The capacity ratio candidate values αᵢ may be a plurality of values selected in a range of 1 or more and 10 or less. According to another example, the capacity ratio candidate values αᵢ may be a plurality of values selected in a range of 1 or more and 5 or less. The capacity ratio candidate values αᵢ may be selected at an interval of 0.1.

According to the method of determining the capacity ratio α according to an embodiment, a current value and a voltage value measured at a battery terminal when the current value is applied to a battery are input at each pre-set timing interval Δt, and operations S22 to S28 are performed at each pre-set timing interval Δt in response to the input current value and voltage value. When both the current value and the voltage value are input, other capacity ratio candidate values αⱼ are selected (S21) and operations S22 to S28 are repeatedly performed with respect to the capacity ratio candidate values αⱼ. In operation S29, an optimal capacity ratio candidate value from among the capacity ratio candidate values αᵢ and αⱼ is determined as the capacity ratio α.

Hereinafter, operations S22 to S27 for outputting calculated voltage values corresponding to current values for the capacity ratio candidate values αᵢ will be described.

A process of performing operations S22 to S27 from a previous timing k−1 that is earlier than a current timing k by the pre-set timing interval Δt will be briefly described.

A current value I_{B}[k−1] and a voltage value V_{B}[k−1] of the previous timing k−1 may be input (S22). Distribution current values I₁[k−1] and I₂[k−1] distributed to the first and second branches BR1 and BR2 are estimated (S23). SOC values SOC₁[k−1] and SOC₂[k−1] of the first and second branches BR1 and BR2 are updated based on the distribution current values I₁[k−1] and I₂[k−1] of the first and second branches BR1 and BR2 (S24).

Open circuit voltage values Voc₁[k−1] and Voc₂[k−1], series resistance values Rs₁[k−1] and Rs₂[k−1], first parallel resistance values Rp₁₁[k−1] and Rp₁₂[k−1], second parallel resistance values Rp₂₁[k−1] and Rp₂₂[k−1], first capacitances Cp₁₁[k−1] and Cp₁₂[k−1], and second capacitances Cp₂₁[k−1] and Cp₂₂[k−1] of the first and second branches BR1 and BR2 are updated based on the SOC values SOC₁[k−1] and SOC₂[k−1] of the first and second branches BR1 and BR2 (S25). First voltage values V₁₁[k−1] and V₁₂[k−1] of both ends of first parallel resistors Rp₁₁ and Rp₁₂ and second voltage values V₂₁[k−1] and V₂₂[k−1] of both ends of second parallel resistors Rp₂₁ and Rp₂₂ of the first and second branches BR1 and BR2 are updated (S26).

A calculated voltage value V_{B_cal}[k−1] of the battery is calculated based on the open circuit voltage values Voc₁[k−1] and Voc₂[k−1], the distribution current values I₁[k−1] and I₂[k−1], the series resistance values Rs₁[k−1] and Rs₂[k−1], the first voltage values V₁₁[k−1] and V₁₂[k−1], and the second voltage values V₂₁[k−1] and V₂₂[k−1] of the first and second branches BR1 and BR2 (S27).

When the pre-set timing interval Δt passes (S110) to reach the current timing k, a current value I_{B}[k] and a voltage value V_{B}[k] of the current timing k are input (S22). Input current I_{B} is distributed to the first and second branches BR1 and BR2.

A first distribution current value I₁[k] distributed to the first branch BR1 and a second distribution current value I₂[k] distributed to the second branch BR2 are estimated (S23). The first distribution current value I₁[k] may be estimated based on the first and second open circuit voltage values Voc₁[k−1] and Voc₂[k−1], the first and second series resistance values Rs₁[k−1] and Rs₂[k−1], and the first voltage values V₁₁[k−1] and V₁₂[k−1] and the second voltage values V₂₁[k−1] and V₂₂[k−1] of the first and second branches BR1 and BR2, updated at the previous timing k−1, and the current value I_{B}[k] received at the current timing k. According to an example, the first distribution current value I₁[k] may be estimated by using Equation 1.

The first and second open circuit voltage values Voc₁[k−1] and Voc₂[k−1] and the first and second series resistance values Rs₁[k−1] and Rs₂[k−1] may be values updated in operation S25 of the previous timing k−1. The first voltage values V₁₁[k−1] and V₁₂[k−1] and the second voltage values V₂₁[k−1] and V₂₂[k−1] of the first and second branches BR1 and BR2 may be values updated in operation S26 of the previous timing k−1.

The second distribution current value I₂[k] may be estimated by using Equation 2.

A first SOC value SOC₁[k] of the first branch BR1 is updated based on the first distribution current value I₁[k], and a second SOC value SOC₂[k] of the second branch BR2 is updated based on the second distribution current value I₂[k] (S24). For example, the first SOC value SOC₁[k] and the second SOC value SOC₂[k] may be calculated by using a current integration method.

According to an example, the first SOC value SOC₁[k] may be calculated based on the first distribution current value I₁[k] and the first SOC value SOC₁[k−1] of the previous timing k−1. The second SOC value SOC₂[k] may be calculated based on the second distribution current value I₂[k] and the second SOC value SOC₂[k−1] of the previous timing k−1. For example, the first SOC value SOC₁[k] may be calculated by using Equation 3, and the second SOC value SOC₂[k] may be calculated by using Equation 4.

A first open circuit voltage value Voc₁[k], a first series resistance value Rs₁[k], a first parallel resistance value Rp₁₁[k], a second parallel resistance value Rp₂₁[k], a first capacitance Cp₁₁[k], and a second capacitance Cp₂₁[k] of the first branch BR1 are updated based on the first SOC value SOC₁[k], and a second open circuit voltage value Voc₂[k], a second series resistance value Rs₂[k], a first parallel resistance value Rp₁₂[k], a second parallel resistance value Rp₂₂[k], a first capacitance Cp₁₂[k], and a second capacitance Cp₂₂[k] of the second branch BR2 are updated based on the second SOC value SOC₂[k] (S25).

When the first SOC value SOC₁[k] and the second SOC value SOC₂[k] are determined in operation S25, by using the SOC-Voc data 121 (see FIG. 3), the first open circuit voltage value Voc₁[k] of the first branch BR1 is determined to be a value corresponding to the first SOC value SOC₁[k], and the second open circuit voltage value Voc₂[k] of the second branch BR2 is determined to be a value corresponding to the second SOC value SOC₂[k].

The first series resistance value Rs₁[k] of the first branch BR1 is determined to be a value obtained by multiplying a series resistance value Rs(SOC₁[k]) corresponding to the first SOC value SOC₁[k] by a first coefficient k1 by using the SOC-Rs data 122 (see FIG. 3) stored in the memory 120 (see FIG. 3), and the second series resistance value Rs₂[k] of the second branch BR2 is determined to be a value obtained by multiplying a series resistance value Rs(SOC₂[k]) corresponding to the second SOC value SOC₂[k] by a sixth coefficient k6 by using the SOC-Rs data 122 (see FIG. 3) stored in the memory 120 (see FIG. 3).

The first parallel resistance value Rp₁₁[k] and the second parallel resistance value Rp₂₁[k] of the first branch BR1 are determined to be values obtained by multiplying a first parallel resistance value Rp₁(SOC₁[k]) and a second parallel resistance value Rp₂(SOC₁[k]) corresponding to the first SOC value SOC₁[k] by a second coefficient k2 and a third coefficient k3 by using the SOC-Rp₁ & Rp₂ data 123 (see FIG. 3) stored in the memory 120 (see FIG. 3). The first parallel resistance value Rp₁₂[k] and the second parallel resistance value Rp₂₂[k] of the second branch BR2 are determined to be values obtained by multiplying a first parallel resistance value Rp₁(SOC₂[k]) and a second parallel resistance value Rp₂(SOC₂[k]) corresponding to the second SOC value SOC₂[k] by a seventh coefficient k7 and an eighth coefficient k8 by using the SOC-Rp₁ & Rp₂ data 123 (see FIG. 3) stored in the memory 120 (see FIG. 3).

The first capacitance Cp₁₁[k] and the second capacitance Cp₂₁[k] of the first branch BR1 are calculated to be values obtained by multiplying a first capacitance Cp₁(SOC₁[k]) and a second capacitance Cp₂(SOC₁[k]) corresponding to the first SOC value SOC₁[k] by a fourth coefficient k4 and a fifth coefficient k5 by using the SOC-Cp₁ & Cp₂ data 124 (see FIG. 3) stored in the memory 120 (see FIG. 3). The first capacitance Cp₁₂[k] and the second capacitance Cp₂₂[k] of the second branch BR2 are determined to be values obtained by multiplying a first capacitance Cp₁(SOC₂[k]) and a second capacitance Cp₂(SOC₂[k]) corresponding to the second SOC value SOC₂[k] by a ninth coefficient k9 and a tenth coefficient k10 by using the SOC-Cp₁ & Cp₂ data 123 (see FIG. 3) stored in the memory 120 (see FIG. 3).

According to another example, the first capacitance Cp₁₁[k] and the second capacitance Cp₂₁[k] of the first branch BR1, and the first capacitance Cp₁₂[k] and the second capacitance Cp₂₂[k] of the second branch BR2 may be determined to be constants regardless of the first SOC value SOC₁[k] and the second SOC value SOC₂[k].

The first to tenth coefficients k1 to k10 may be determined based on the capacity ratio candidate values αᵢ. The first to third coefficients k1, k2, and k3 may be 1+1/αᵢ, and the sixth to eighth coefficients k6, k7, and k8 may be 1+αᵢ. The fourth and fifth coefficients k4 and k5 may be (1+1/αᵢ)⁻¹, that is, αᵢ/(1+αᵢ), and the ninth and tenth coefficients k9 and k10 may be (1+αᵢ)⁻¹, that is, 1/(1+αᵢ).

In this case, the first series resistance value Rs₁[k], the first parallel resistance value Rp₁₁[k], and the second parallel resistance value Rp₂₁[k] of the first branch BR1 may be respectively determined to be (1+1/αᵢ)*Rs(SOC₁[k]), (1+1/αᵢ)*Rp₁(SOC₁[k]), and (1+1/αᵢ)*Rp₂(SOC₁[k]). The first capacitance Cp₁₁[k] and the second capacitance Cp₂₁[k] of the first branch BR1 may be respectively determined to be αᵢ/(1+αᵢ)*Cp₁(SOC₁[k]) and αᵢ(1+αᵢ)*Cp₂(SOC₁[k]).

The second series resistance value Rs₂[k], the first parallel resistance value Rp₁₂[k], and the second parallel resistance value Rp₂₂[k] of the second branch BR2 may be respectively determined to be (1+αᵢ)*Rs(SOC₂[k]), (1+αᵢ)*Rp₁(SOC₂[k]), and (1+αᵢ)*Rp₂(SOC₂[k]). The first capacitance Cp₁₂[k] and the second capacitance Cp₂₂[k] of the second branch BR2 may be respectively determined to be 1/(1+αᵢ)*Cp₁(SOC₂[k]) and 1/(1+αᵢ)*Cp₂(SOC₂[k]).

The first voltage value V₁₁[k] and the second voltage value V₂₁[k] of the first branch BR1 and the first voltage value V₁₂[k] and the second voltage value V₂₂[k] of the second branch Br2 are updated (S26).

The first voltage value V₁₁[k] of the first branch BR1 may be updated based on the first voltage value V₁₁[k−1] of the previous timing k−1, and the first distribution current I₁[k], the first parallel resistance value Rp₁₁[k], and the first capacitance Cp₁₁[k] of the current timing k. For example, the first voltage value V₁₁[k] of the first branch BR1 may be calculated according to Equation 5.

The second voltage value V₂₁[k] of the first branch BR1 may be updated based on the second voltage value V₂₁[k−1] of the previous timing k−1, and the first distribution current I₁[k], the second parallel resistance value Rp₂₁[k], and the second capacitance Cp₂₁[k] of the current timing k. For example, the second voltage value V₂₁[k] of the first branch BR1 may be calculated according to Equation 6.

The first voltage value V₁₂[k] of the second branch BR2 may be updated based on the first voltage value V₁₂[k−1] of the previous timing k−1, and the second distribution current I₂[k], the first parallel resistance value Rp₁₂[k], and the first capacitance Cp₁₂[k] of the current timing k. For example, the first voltage value V₁₂[k] of the second branch BR2 may be calculated according to Equation 7.

The second voltage value V₂₂[k] of the second branch BR2 may be updated based on the second voltage value V₂₂[k−1] of the previous timing k−1, and the second distribution current I₂[k], the second parallel resistance value Rp₂₂[k], and the second capacitance Cp₂₂[k] of the current timing k. For example, the second voltage value V₂₂[k] of the second branch BR2 may be calculated according to Equation 8.

A first calculated voltage value V_{B1_cal}[k] of the battery is calculated based on the first open circuit voltage value Voc₁[k], the first distribution current value I₁[k], the first series resistance value Rs₁[k], and the first voltage value V₁₁[k] and the second voltage value V₂₁[k] of the first branch BR1, and a second calculated voltage value V_{B2_cal}[k] of the battery is calculated based on the second open circuit voltage value Voc₂[k], the second distribution current value I₂[k], the second series resistance value Rs₂[k], and the first voltage value V₁₂[k] and the second voltage value V₂₂[k] of the second branch BR2.

For example, the first calculated voltage value V_{B1_cal}[k] and the second calculated voltage value V_{B2_cal}[k] may be calculated by Equation 12.

V_{B1_cal}=Voc₁[k]−V₁₁[k]−V₂₁[k]−I₁[k]Rs₁[k]

V_{B2_cal}=Voc₂[k]−V₁₂[k]−V₂₂[k]−I₂[k]Rs₂[k] [Equation 12]

A calculated voltage value V_{B_cal}[k] of the battery is determined based on the first calculated voltage value V_{B1_cal}[k] and the second calculated voltage value V_{B2_cal}[k] (S27). For example, the calculated voltage value V_{B_cal}[k] of the battery may be one of the first calculated voltage value V_{B1_cal}[k] and the second calculated voltage value V_{B2_cal}[k], or may be an average value of the first calculated voltage value V_{B1_cal}[k] and the second calculated voltage value V_{B2_cal}[k].

A deviation between the first calculated voltage value V_{B1_cal}[k] and the second calculated voltage value V_{B2_cal}[k] may be compared with a pre-set reference value, and when the deviation between the first calculated voltage value V_{B1_cal}[k] and the second calculated voltage value V_{B2_cal}[k] is within the pre-set reference value, the calculated voltage value V_{B_cal}[k] of the battery may be determined based on the first calculated voltage value V_{B1_cal}[k] and the second calculated voltage value V_{B2_cal}[k].

When the deviation between the first calculated voltage value V_{B1_cal}[k] and the second calculated voltage value V_{B2_cal}[k] exceeds the pre-set reference, a process of calculating a calculated voltage value of the battery may not be performed with the capacity ratio candidate values αᵢ, but a process of calculating a calculated voltage value of the battery may be performed with respect to other capacity ratio candidate values αⱼ.

When the calculated voltage value V_{B_cal}[k] of the battery is calculated (S27), a current value I_{B}[k+1] and a voltage value V_{B}[k+1] of a next timing k+1 are input (S22). A calculated voltage value V_{B_cal}[k+1] is calculated by repeatedly performing operations S23-27 with respect to the input current value I_{B}[k+1]. In this way, calculated voltage values of all current values may be calculated.

Next, calculated voltage values of all current values may also be calculated for other capacity ratio candidate values αⱼ.

An error between the calculated voltage value V_{B_cal}[k] for each capacity ratio candidate value αⱼ and the voltage value V_{B_cal}[k] input in operation S22 may be calculated, and the capacity ratio candidate value αⱼ having a smallest error may be determined as the capacity ratio α (S29). For example, the capacity ratio α may be determined by Equation 13.

$$α = arg {min}_{α} {\sum }_{k} {( {V}_{B \_ cal} [ k ] - {V}_{B} [ k ] )}^{2} \qquad [ Equation 13 ]$$

Because the capacity ratio α determined as described above reflects non-uniformity of an internal state of the battery, accurate modeling and simulation of the battery may be provided.

The spirit of the present disclosure is not limited to the above-described embodiments, and all ranges equivalent to the claims or equivalently changed therefrom as well as the claims described below belong to the scope of the spirit of the present disclosure.

1. A battery simulation method performed by a computing device comprising a processor and a memory, the battery simulation method comprising:
selecting an equivalent circuit model of a battery comprising first and second branches comprising a voltage source connected in series, a series resistor, a first parallel resistor and a first capacitor connected in parallel, and a second parallel resistor and a second capacitor connected in parallel;
setting a capacity ratio of the first and second branches;
receiving a current value;
estimating a distribution current value distributed to each branch;
updating a state of charge (SOC) value of each branch, based on the distribution current value of each branch;
determining an open circuit voltage value, a series resistance value, a first parallel resistance value, a second parallel resistance value, a first capacitance, and a second capacitance of each branch, based on the SOC value of each branch;
determining a first voltage value of both ends of the first parallel resistor and a second voltage value of both ends of the second parallel resistor, of each branch;
calculating a G parameter value and an H parameter value of the battery, based on the open circuit voltage value, the series resistance value, the first voltage value, and the second voltage value, of each branch; and
calculating an estimated voltage value of the battery, based on the G parameter value and the H parameter value of the battery.

2. The battery simulation method of claim 1, wherein
the G parameter value of the battery is a value indicating a sensitivity of a voltage to a change in current of the battery, and
the H parameter of the battery is a value indicating an effective potential determined by a local equilibrium potential distribution and a resistance distribution in the battery.

3. The battery simulation method of claim 1, wherein the calculating of the G parameter value and the H parameter value of the battery comprises:
calculating a G parameter value and an H parameter value of each branch, based on the open circuit voltage value, the series resistance value, the first voltage value, and the second voltage value, of each branch; and
calculating a G parameter value and an H parameter value of the battery, based on the G parameter value and the H parameter value of each branch.

4. The battery simulation method of claim 3, wherein
the G parameter value of each branch is determined to be the series resistance value of each branch, and
the H parameter value of each branch is determined to be a value obtained by subtracting the first voltage value and the second voltage value of each branch from the open circuit voltage value of each branch.

5. The battery simulation method of claim 3, wherein
the G parameter value of the battery is determined by G_{B}[k]=((G₁[k])⁻¹+(G₂[k])⁻¹)⁻¹, and
the H parameter value of the battery is determined by H_{B}[k]=(H₁[k]/G₁[k]+H₂[k]/G₂[k])/(1/G₁[k]+1/G₂[k]),
wherein G_{B}[k] and H_{B}[k] are respectively the G parameter value and the H parameter value of the battery, G₁[k] and H₂[k] are respectively the G parameter value and the H parameter value of the first branch, and G₁[k] and H₂[k] are respectively the G parameter value and the H parameter value of the second branch.

6. The battery simulation method of claim 1, wherein an estimated voltage value of the battery is calculated by V_{B_est}[k]=H_{B}[k]+G_{B}[k] *I_{B}[k],
wherein V_{B_est}[k] is the estimated voltage value of the battery, G_{B}[k] and H_{B}[k] are respectively the G parameter value and the H parameter value of the battery, and I_{B}[k] is the current value.

7. The battery simulation method of claim 1, further comprising receiving parameter data of each of parameter values for an SOC value, collected for a 1-branch equivalent circuit model comprising a voltage source connected in series, a series resistor, a first parallel resistor and a first capacitor connected in parallel, and a second parallel resistor and a second capacitor connected in parallel,
wherein the parameter values comprise an open circuit voltage value, a series resistance value, a first parallel resistance value, a second parallel resistance value, a first capacitance, and a second capacitance of the 1-branch equivalent circuit model.

8. The battery simulation method of claim 7, wherein the open circuit voltage value, the series resistance value, the first parallel resistance value, the second parallel resistance value, the first capacitance, and the second capacitance of each branch are determined based on the SOC value of each branch and a capacity ratio α of the first and second branches by referring to the parameter data,
wherein a capacity of the first branch and a capacity of the second branch are set to α:1.

9. The battery simulation method of claim 1, wherein
the first voltage value of each branch is calculated based on a first previous voltage value of both ends of the first parallel resistor of each branch, the distribution current value distributed to each branch, and the first parallel resistance value and the first capacitance of each branch, and
the second voltage value of each branch is calculated based on a second previous voltage value of both ends of the second parallel resistor of each branch, the distribution current value distributed to each branch, and the second parallel resistance value and the second capacitance of each branch.

10. The battery simulation method of claim 1, wherein the SOC value of each branch is calculated by using a current integration method based on a previous SOC value of each branch and the distribution current value of each branch.

11. The battery simulation method of claim 1, wherein the distribution current value of each branch is calculated based on the current value, a previous open circuit voltage value of each of the first and second branches, a previous series resistance value, a first previous voltage value, and a second previous voltage value.

12. The battery simulation method of claim 1, wherein the setting of the capacity ratio of the first and second branches comprises:
selecting candidate capacity ratios of the first and second branches;
receiving an input current value and an input voltage value;
estimating a distribution current value distributed to each branch;
updating an SOC value of each branch, based on the distribution current value of each branch;
determining an open circuit voltage value, a series resistance value, a first parallel resistance value, a second parallel resistance value, a first capacitance, and a second capacitance of each branch, based on the SOC value of each branch;
determining a first voltage value of both ends of the first parallel resistor and a second voltage value of both ends of the second parallel resistor of each branch;
calculating a calculated voltage value of the battery; and
determining a candidate capacity ratio at which a difference between the input voltage value and the calculated voltage value of the battery is a minimum value as the capacity ratio.

13. A computer program stored in a medium to execute the battery simulation method according to claim 1 by using a computing device comprising a processor and a memory.
